(19) United States
(12) Patent Application Publication
(10) Pub. No.: US 2007/0220617 A1
(43) Pub. Date: Sep. 20, 2007

(54) System for Distributing Digital Contents and Method Thereof

(76) Inventors: Won Young Yoo, Yusong-Gu (KR); Seon Hwa Lee, Yusong-Gu (KR); Young Ho Suh, Yusong-Gu (KR); Hyun Bin Kim, Yusong-Gu (KR)

Correspondence Address: RABIN & Berdo, PC, 1101 14TH STREET, NW, SUITE 500, WASHINGTON, DC, 20005, US

(21) Appl. No.: 11/572,850

(22) PCT Filed: Nov. 4, 2004
(86) PCT No.: PCT/KR04/02830

§ 371 Date: Jan. 29, 2007

(30) Foreign Application Priority Data
Aug. 6, 2004 (KR) 1020040061917

(51) Int. Cl. H04L 9/32

(52) U.S. Cl. 726/32

(57) ABSTRACT

Disclosed is a system for distributing digital contents which can pursue a purchaser who has illegally redistributed the contents by inserting fingerprinting information into the digital contents. The system includes a contents creation server for creating the digital contents, a contents distribution server for encrypting the digital contents, distributing the encrypted digital contents to a client who has requested a purchase of the digital contents, and transmitting purchaser information to a clearing house, the clearing house for transmitting the purchaser information to a fingerprinting management server, and transmitting a license and a fingerprinting code received from the fingerprinting management server to a client, the fingerprinting management server for creating the fingerprinting code from the purchaser information, and transmitting the created fingerprinting code to the clearing house; and the client for decrypting the encrypted digital contents using the license, inserting the fingerprinting code into the decrypted digital contents and then playing the digital contents.

### TECHNICAL FIELD

The present invention relates to a system for distributing digital contents, and more particularly to a system for distributing digital contents which can purse a purchaser who has illegally redistributed the contents by inserting fingerprinting information (i.e., purchaser information) into the digital contents.

### BACKGROUND ART

As electronic commerce through Internet becomes active, digital multimedia contents such as music files in the form of an MP3 or various kinds of moving images for education have also been produced and sold actively. Also, traditional contents industries such as publication, education and motion picture industries are rapidly being digitalized for marketing using the Internet. However, unlike analog data, since a complete copying of digital contents can be made and a mass distribution of the digital contents can easily be performed through the Internet, illegal copying and redistribution of the digital contents have frequently been performed, and this causes contents providers to suffer financial damage and acts as an obstacle to activation of the contents industry. Accordingly, in order to protect rights from the illegal copying of the digital contents, encryption methods have been applied to software contents. According to the conventional encryption methods, encrypted contents are transmitted to a purchaser, and the purchaser having an authority to access and use the contents using serial numbers given through a registration procedure decrypts the contents using a proper decryption key. Thereafter, if contents that are suspected to be an illegal copy is found, the origin of the illegal distributor can be pursed using the key used for the decryption or the serial numbers. However, the existing encryption method has no countermeasure against the contents redistribution action of an ill-intentioned purchaser. Actually, multimedia contents such as music files or moving images are mostly redistributed without being captured and encrypted after they are decrypted or played. Accordingly, this encryption method has a limit in protecting the right of multimedia contents.

In order to solve the problems of the above-described limited encryption method, watermarking technology that serves to insert copyright information into the contents so that the purchaser cannot recognize the information has been proposed. According to this watermarking technology, multimedia contents such as images, audios and videos, text and text files are distributed with copyright information for indicating the original owner, i.e., watermark, inserted thereto, and the watermark is extracted after illegal copying of them in order to provide a legal basis for verifying the original owner. However, this watermarking technology has the problems in that it is impossible to distinguish the illegal distributor only by the extracted watermark.

FIG. 1 is a block diagram illustrating the construction of a general system for distributing contents that is related to a conventional digital rights management (DRM) system.

Referring to FIG. 1, if a client 10 accesses a contents distribution server 20 and request a purchase of specified contents, the contents distribution server 20 transfers purchase information inputted from the client 10 to a clearing house 30. If the clearing house 30 re-transfers the purchase information transferred from the clearing house 30 to a contents creation server 40 and issues a license to the client 10, the contents distribution server 20 receives and encrypts the contents created by the contents creation server 40 and provides the encrypted contents to the client 10 to which the license has been issued. However, the existing DRM system can protect and manage copyright only up to the client stage. In other words, the existing DRM system has no countermeasure against contents redistribution action of an ill-intentioned purchaser as a legal subscriber after he/she illegally copies or re-processes the legal original contents decrypted at the client stage.

### DISCLCSURE OF THE INVENTION

Therefore, the present invention has been made to solve the above-mentioned problems occurring in the prior art, and an object of the present invention is to provide a system for distributing digital contents and a method thereof which can purse a purchaser who has illegally distributed the contents using purchaser information extracted from the corresponding contents if the contents has illegally been copied and distributed by inserting a fingerprinting code into the contents just before the contents are played by a purchaser's computer.

Another object of the present invention is to provide a system for distributing digital contents and a method thereof which can solve a load problem and a superdistribution problem in a server if the contents to be played refer to a large-capacity file such as a moving image by inserting a fingerprint into the contents at a client stage.

Additional advantages, objects, and features of the invention will be set forth in part in the description which follows and in part will become apparent to these having ordinary skill in the art upon examination of the following or may be learned from practice of the invention.

In order to accomplish the above-mentioned objects, a system for distributing digital contents according to the present invention comprises a contents creation server for creating the digital contents; a contents distribution server for encrypting the digital contents created by the contents creation server, distributing the encrypted digital contents to a client who has requested a purchase of the digital contents, and transmitting purchaser information to a clearing house; the clearing house fir transmitting the purchaser information received from the contents distribution server to a fingerprinting management server, and transmitting a license and a fingerprinting code received from the fingerprinting management server to a client; the fingerprinting management server for creating the fingerprinting code from the purchaser information received from the clearing house, and transmitting the created fingerprinting code to the clearing house; and the client for decrypting the encrypted digital contents received from the contents distribution server using the license received from the clearing house, inserting the fingerprinting code received from the fingerprinting management server into the decrypted digital contents and then playing the digital contents.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a block diagram illustrating the construction of a general system for distributing contents that is related to a conventional digital rights management (DRM) system;

FIG. 2 is a block diagram illustrating the construction of a system for distributing digital contents according to the present invention;

FIG. 3 is a block diagram illustrating the construction of a fingerprinting management server of FIG. 2;

FIG. 4 is a block diagram illustrating the construction of a client module of FIG. 2; and

FIG. 5 is a flowchart illustrating a process of distributing digital contents according to the present invention.

### BEST MODE FOR CARRYING OUT THE INVENTION

Now, a system for distributing digital contents and a method thereof according to preferred embodiments of the present invention will be described in detail with reference to the annexed drawings.

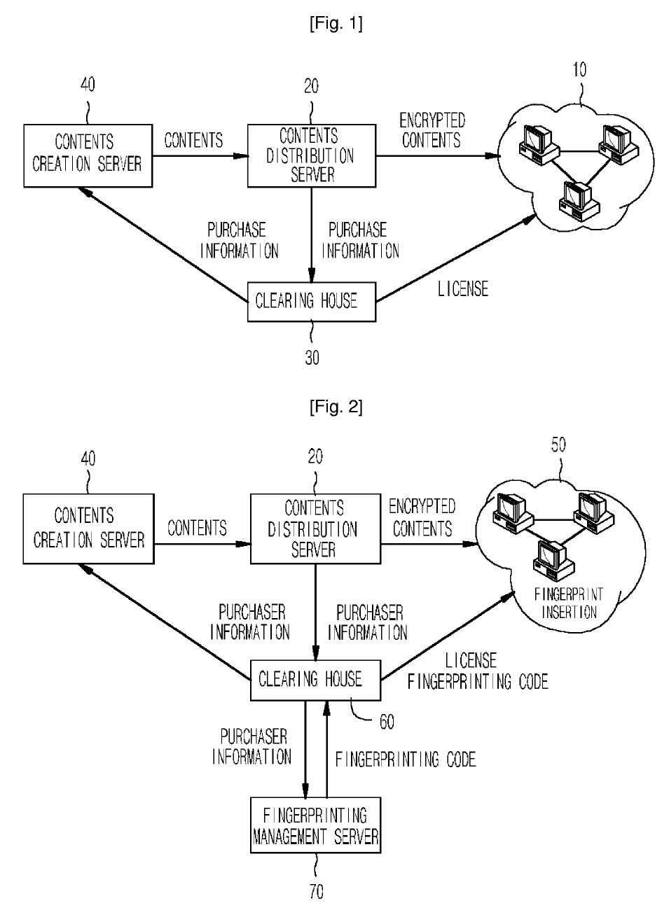

FIG. 2 is a block diagram illustrating the construction of a system for distributing digital contents according to the present invention. In the following description of the present invention, the same drawing reference numerals are used for the same elements among/across FIGS. 1 and 2.

The system for distributing digital contents according to the present invention includes a client 50 for receiving the digital contents, a contents creation server 40 for creating the digital contents, a contents distribution server 20 for distributing the digital contents created by the contents creation server 40 to the client 50, a clearing house 60 for receiving purchaser information of a contents purchaser from the contents distribution server 20 and issuing a license to the client 50, and a fingerprinting management server 70 for receiving fingerprinting information (i.e., the purchaser information) from the clearing house 60 and creating a fingerprinting code.

If the contents distribution server 20 receives a purchase request for specified contents from the client 50, it transmits the inputted purchaser information to the clearing house 60.

The clearing house 60 transmits the purchaser information received from the contents distribution server to the contents creation server 40, and simultaneously issues the license to the client 50 who has requested the purchase. Also, the clearing house 60 transmits the fingerprinting information that is the purchaser information received from the contents distribution server to the fingerprinting management server 70.

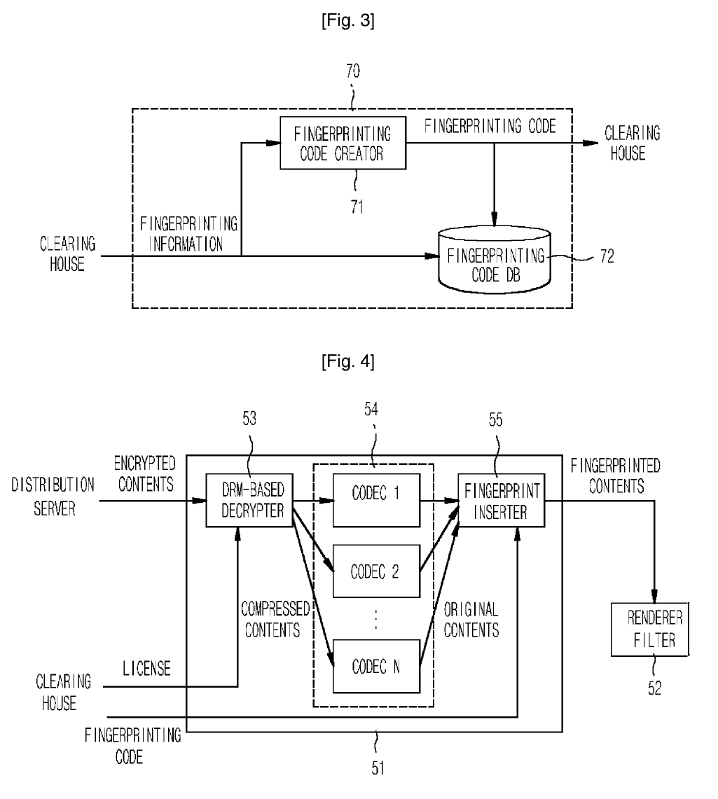

The fingerprinting management server 70, as shown in FIG. 3, includes a fingerprinting code creator 71 for receiving the fingerprinting information from the clearing house 60 and creating the fingerprinting code, and a fingerprinting code database 72 for storing the purchaser information received from the clearing house 60 and the fingerprinting code created from the fingerprinting code creator 71. Here, the databased fingerprinting code information is used for applications to the pursuit of illegal contents and so on, and the fingerprinting code created through the fingerprinting code creator 71 is transmitted to the clearing house 60. Particularly, the term ‘illegal contents’ means the contents which are distributed without any distribution right given under the corresponding copyright law from a copyright holder who owns the legal copyright of the digital contents or a copyright information provider who creates and manages the basis of the copyright holder. Generally, the illegal contents means simply copied contents and contents recreated by delivering various attacks.

The clearing house 60 transmits the fingerprinting code received from the fingerprinting management server 70 to the client 50. At the same time, the contents creation server 40 that has received the purchaser information from the clearing house 60 can confirm whether its contents have been sold. Then, the contents are encrypted by the contents distribution server 20, and transmitted to the client 50.

Generally, on the MS Windows platform, even general players provided in the system can play multimedia streams. These general players play the multimedia streams using COM (Component Object Model)-based contents decoders registered in the system. COM-based codec combination may automatically be performed according to the source type of the media stream, or the player may optionally designate the codec combination.

In the present invention, as shown in FIG. 4, the client 50, which freely uses the existing COM-based codecs and to which an encryption module used in the distribution system and a fingerprinting insertion module for inserting the fingerprinting information are added, includes a management filter 51 for inserting the respective fingerprinting information according to the purchasers into the contents and managing the fingerprinting information, and a renderer filter 52 for displaying the digital contents into which the fingerprinting code outputted from the management filter 51 is inserted on a display screen. The client module having a built-in fingerprinting inserter may use the diverse existing players x) that the contents can be played without being affected by the content format.

Particularly, the management filter 51 may comprise a DRM-based decrypter 53 for receiving the license transmitted from the clearing house 60 and decrypting the encrypted contents received from the contents distribution server 20 so that the fingerprinting information is inserted at a preceding stage of a contents output stage, a codec 54 for compressing and playing the contents decrypted by the decrypter 53, and a fingerprint inserter 55 for inserting the fingerprinting code received from the clearing house 60 into the contents decompressed by the codec 54. The renderer filter 52 of the client may judge whether the fingerprinting code is removed, in addition to the display of the digital contents on the screen, and if the fingerprinting code is removed by an illegal hacking and so on, the renderer filter 52 may stop the playback of the digital contents.

That is, the present invention does not relate to the simple distribution of the encrypted contents so that an authenticated user can decrypt the encrypted contents, but relates to the insertion of the fingerprinting code into the contents decrypted through the fingerprint inserter 55 to output the fingerprinted contents before the contents is outputted to the display screen.

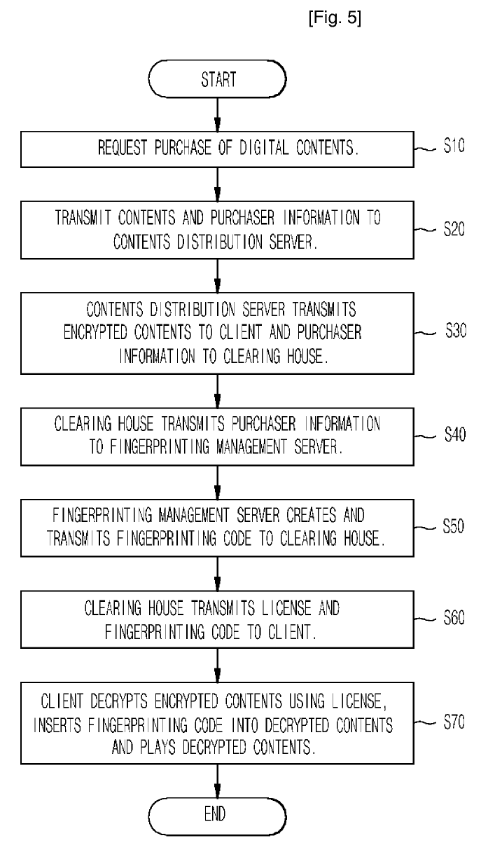

FIG. 5 is a flowchart illustrating a process of distributing digital contents according to the present invention.

Referring to FIG. 5, if a purchaser requests a purchase of specified digital contents to the contents creation server 40 (step S10), the contents creation server 40 transmits the digital contents requested by the purchaser and purchaser information to the contents distribution server 20 (step S20). Accordingly, the contents distribution server 20 encrypts the digital contents received from the contents creation server 40, transmits the encrypted digital contents to the client 50 and transmits the purchaser information to the clearing house 60 (step S30).

Then, if the clearing house 60 transmits the purchaser information to the fingerprinting management server 70 (step S40), the fingerprinting management server 70 creates the fingerprinting code based on the received purchaser information and transmits the created fingerprinting code to the clearing house 60 (step S50).

Then, if the clearing house 60 transmits the created license and the fingerprinting code received from the fingerprinting management server 70 to the client 50 (step S60), the client 50 decrypts the encrypted digital contents received from the contents distribution server 20 at step S30 using the license, and plays the decrypted contents with the fingerprinting code inserted into the decrypted contents (step S70). However, if the fingerprinting code is not inserted when the client 50 plays the decrypted digital contents, the playback of the digital contents is compulsorily terminated.

The method for distributing the digital contents according to the embodiment of the present invention can be implemented by a computer program, and then stored in a recording medium such as a hard disc, floppy disc, optomagnetic disc, CD-ROM, ROM, RAM, etc.

### INDUSTRIAL APPLICABILITY

As apparent from the above description, according to the system for distributing digital contents and a method thereof according to the present invention, evidence for searching the contents illegally used on the web and pursuing the offender can be secured by inserting the fingerprinting code into the decrypted contents. Also, the right of the digital contents right holder can be protected and the activity of the digital contents industry can be promoted by eradicating the illegal act through monitoring and controlling of the circulation of illegal contents.

Also, the present invention can prevent the user's ill-intentioned deletion of the fingerprinting inserter and prevent the hacking without being affected by the media type of the contents by constructing the management filter of the client which is composed of the DRM-based decrypter for decrypting the encrypted contents transmitted from the contents distribution system and the fingerprinting inserter for receiving the fingerprinting information transmitted from the clearing house and inserting the fingerprinting code.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

1. A system for distributing digital contents comprising:
a contents creation server for creating the digital contents;
a contents distribution server for encrypting the digital contents created by the contents creation server, distributing the encrypted digital contents to a client who has requested a purchase of the digital contents, and transmitting purchaser information to a clearing house;
the clearing house for transmitting the purchaser information received from the contents distribution server to a fingerprinting management server, and transmitting a license and a fingerprinting code received from the fingerprinting management server to a client;
the fingerprinting management server for creating the fingerprinting code from the purchaser information received from the clearing house, and transmitting the created fingerprinting code to the clearing house; and
the client for decrypting the encrypted digital contents received from the contents distribution server using the license received from the clearing house, inserting the fingerprinting code received from the fingerprinting management server into the decrypted digital contents and then playing the decrypted digital contents.

2. The system as claimed in claim 1, wherein the fingerprinting management server comprises:
a fingerprinting code creator for creating the fingerprinting code based on the purchaser information received from the clearing house; and
a fingerprinting code database for storing the purchaser information received from the clearing house and the fingerprinting code created from the fingerprinting code creator.

3. A client in a system for distributing digital contents, comprising:
a decryption unit for decrypting encrypted digital contents received from a contents distribution server using a license received from a clearing house;
a fingerprinting insertion unit for inserting fingerprinting code received from a fingerprinting management server into the decrypted digital contents; and
a renderer filter for playing the digital contents into which the fingerprinting code is inserted by the fingerprinting insertion unit.

4. The client as claimed in claim 3, further comprising a plurality of codecs for playing compressed digital contents according to a compression type and transferring the digital contents to the fingerprinting insertion unit if the digital contents decrypted by the decryption unit are compressed multimedia data.

5. The client as claimed in claim 3, wherein the renderer filter of the client judges whether a fingerprinting code is removed, and if it is judged that the fingerprinting code is removed, the renderer filter stops playing of the digital contents.

6. A method for distributing digital contents, comprising the steps of:
(a) a purchaser requesting a purchase of the digital contents to a contents distribution server;
(b) the contents creation server transmitting the digital contents purchased by the purchaser to a contents distribution server and receiving the purchaser information from a clearing house
(c) the contents distribution server encrypting and transmitting the digital contents received from the contents creation server to a client and transmitting the purchaser information to a clearing house;
(d) the clearing house transmitting the purchaser information to a fingerprinting management server;
(e) the fingerprinting management server creating a fingerprinting code based on the received purchaser information and transmitting the fingerprinting code to the clearing house; and
(f) the clearing house transmitting a license created by the clearing house and the fingerprinting code received from the fingerprinting management server to the client.

7. The method as claimed in claim 6, further comprising the step of (g) the client, which has received the encrypted digital contents, the license and the fingerprinting code, decrypting the encrypted digital contents using the license, inserting the fingerprinting code into the decrypted digital contents and then playing the decrypted digital contents.

8. The method as claimed in claim 7, further comprising the step of (h) the client compulsorily stopping the playing of the decrypted digital contents if the fingerprinting code is not inserted into the decrypted digital contents.
